(19) United States
(12) Patent Application Publication
(10) Pub. No.: US 2008/0098012 A1
(43) Pub. Date: Apr. 24, 2008

(54) Inferring Context

(75) Inventors: Andrew Waywood, Port Melbourne (AU); John Barratt, Kensington (AU); Ian MacDonald Hogan, Mount Waverly (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: ANDREW WAYWOOD, PORT MELBOURNE (AU)

(21) Appl. No.: 11/813,714

(22) PCT Filed: Jan. 13, 2006
(86) PCT No.: PCT/AU06/00040

§ 371 Date: Oct. 11, 2007

(30) Foreign Application Priority Data
Jan. 14, 2005 (AU) 2005900138

(51) Int. Cl. G06F 17/30

(52) U.S. Cl. 707/100; 707/E17.005

(57) ABSTRACT

Method for obtaining contextual information about an item based on information taken from or influenced by other items according to the relationships said item shares with other items, including the steps of (1) determining direct and indirect information of items, where the direct information includes generating a plurality of sets of structures, each structure relating to information about items and types of relationships between them, and each set consisting of common types of relationships between items, (2) determining direct and indirect relationships between items, where the direct relationship is selected from a set of potential relationships, (3) identifying classes or types of relationships that infer information about an item, (4) specifying correspondence between different types of relationships, and (5) combining the direct and indirect information of an item to establish its contextual information.

### FIELD OF THE INVENTION

The present invention broadly relates to the organisation of information in an information system, for example the retrieval or identification of relevant information from a pool of information. The invention relates particularly to a method for determining contextual information of an item which has one or more relationships with other items.

### BACKGROUND OF THE INVENTION

Conventionally, computer systems are designed and used to follow the explicit instructions of the programmer or user. This means that each application of a computer system behaves in exactly the same way, regardless of, for example, the identity of the user or the time of day. While this has advantages in terms of standardisation, it reduces productivity by reducing the scope for automated system customisation.

Some efforts at customisation have been attempted. For example, some applications have functions “greyed out” or unavailable if a user does not have sufficient privileges. This is a simplistic approach, and cannot take into account other aspects of the environment in which the application is operating.

Research is currently being conducted into “contextual computing”, that is, how contextual information about users, documents, and systems can be taken into account to enhance application services. To take contextual information into account in providing application services, the contextual information of any item in a system of items must be able to be calculated. Calculating information about an item from other variables or items within the system enables the relevance of items to be determined. Depending on the other items or variables (including contextual information about users, documents and systems) an item can be classified as used or not used, or alternatively, as available/not available, presented/not presented or viewable/not viewable.

### SUMMARY OF THE INVENTION

In a first aspect, the present invention provides a method for determining contextual information of an item which has one or more relationships with other items, the method comprising the steps of:
determining direct information of the item by identifying one or more of the other items with which the item has a direct relationship;
identifying a class of relationships within the one or more relationships to determine indirect information of the item;
determining the indirect information of the item by determining contextual information of said one or more items with which the item has a relationship falling within the class of relationships; and
combining the direct information and the indirect information to determine the contextual information.

The direct relationship is preferably selected from a set of potential relationships. The selection of a direct relationship from the set of potential relationships preferably includes the step of determining the contextual information of the relationships in the set of potential relationships.

Preferably the relationships comprise two or more different types of relationship, and identifying a class of relationships within the one or more relationships includes the step of determining the contextual information of each type of relationship.

The method preferably further includes the step of specifying a correspondence between a first and second type of relationship of the one or more relationships, the step of determining direct information including the steps of
determining first information by identifying one or more of the other items with which the item has a direct relationship of any type;
determining second information by identifying one or more of the other items which have a relationship of the second type with items which are related to the item by a relationship of the first type; and
combining the first and second information.

Preferably the step of determining direct information of the item includes assembling a plurality of sets of structures, each structure relating to a single item of the said one or more items and containing information representing the type of relationship between the item and said single item and the identity of the said single item, each set comprising structures containing information representing a common type of relationship.

Additionally, it is also preferable if the indirect information consists of a plurality of sets of structures, each structure containing information representing a type of relationship and the identity of an item, each set comprising structures containing information representing a common type of relationship.

The step of combining the direct information and the indirect information preferably includes one or more operations, the nature of the operations being dependent on the nature of the items comprising the direct and indirect information.

In a second aspect, the present invention provides a method for determining contextual information of an item which has one or more relationships with other items, the relationships being of two or more different types, the method comprising the steps of:
specifying a correspondence between a first and second type of relationship of the one or more relationships;
identifying one or more types of relationships to determine indirect information of the item;
determining direct information of the item by
   determining first information by identifying one or more of the other items with which the item has a direct relationship of any type;
   determining second information by identifying one or more of the other items which have a relationship of the second type with items which are related to the item by a relationship of the first type;
   combining the first and second information;
determining the indirect information of the item by determining contextual information of said one or more items with which the item has a relationship of a type used to determine the indirect information of the item; and
combining the direct information and the indirect information to determine the contextual information.

The direct relationship is preferably selected from a set of potential relationships. The selection of a direct relationship from the set of potential relationships preferably includes the step of determining the contextual information of the relationships in the set of potential relationships.

Preferably, the step of identifying one or more types of relationships which may be used to determine the indirect information of the item includes the step of determining the contextual information of each type of relationship.

It is also preferable if the step of determining first information includes assembling a plurality of sets of structures, each structure relating to a single item of the said one or more items and containing information representing the type of relationship between the item and said single item and the identity of the said single item, each set comprising structures containing information representing a common type of relationship.

The step of determining second information preferably includes assembling a plurality of sets of structures, each structure relating to a single item of the said one or more other items and containing information representing the type of relationship between the item and the item with which it has a relationship of the second type, and the identity of the said single item, each set comprising structures containing information representing a common type of relationship.

Preferably the step of combining the first and second information includes one or more operations, the nature of the operations being dependent on the nature of the items comprising the direct and indirect information.

The indirect information preferably consists of a plurality of sets of structures, each structure containing information representing a type of relationship and the identity of an item, each set comprising structures containing information representing a common type of relationship.

It is also preferable if the step of combining the direct information and the indirect information includes one or more operations, the nature of the operations being dependent on the nature of the items comprising the direct and indirect information.

In this specification the word “context” and “contextual” is used to denote information about an item which includes information obtained from or influenced by other items.

### BRIEF DESCRIPTION OF THE FIGURES

FIG. 1 is an illustration of items having one or more relationships with other items where the direct information of items comprises first and second information, and the contextual information of the items has been calculated in accordance with a preferred embodiment of the present invention.

FIG. 2 is an illustration of a model of an educational application for resource discovery and reporting, including representations of items and relationships.

FIG. 3 is an illustration of the model of FIG. 2 with a different user querying the educational application.

FIG. 4 is an illustration of the items and relationships representing sections of a book and a user of a query application, Joe Smith.

FIG. 5 is an illustration of the items and relationships of FIG. 4 and a user of the query application, Mark Jones.

### DETAILED DESCRIPTION OF THE PREFERRED EMBODIMENT

Items of Information, Context and Viewability

A preferred embodiment of the present invention involves the calculation or determination of information about an item or object. Each item or object may be considered to be embedded in a knowledge domain that is representable as an n-dimensional space where each dimension is a dimension of classification. In other words, each object has one or more preferably orthogonal dimensions associated with it. Dimensions can be of any type, for example:
Bit-set Allows selection from a finite list of discrete values. For example, language, encoding format, etc.
Tree Allows selection of one or more branches of a hierarchical tree of values. For example, a taxonomy for areas of study, organisational unit in a business, available webservices etc.
Value Range This includes ranges of different types, for example ranges of integer values, floating point values, dates etc. It allows for the specification of a contiguous span of values, for example a contiguous span of dates.
List Allows selection of one or more values from a list or set of possible values. For example a list of priorities, or item categorisations.

The direct information of an item or object is then a set of context dimensions, each of which is a subset of its dimension.

When two items, for example O¹ and O², have a relationship, either parent-child through containment, or reference through directed links, then the combination of the two objects direct information determines the visibility of the dependent object from the independent object (and hence the relevance of the dependent object to the independent object). The direct information of an object can be considered a set of values, each value corresponding with a dimension.

A common combining operation is the intersection operation. To determine the intersection of the direct information of two items, the intersection operation is performed dimension by dimension.

If O* represents the direct information of the object O, then:
O*=[D₁,D₂, . . . ,Dₙ], where Dᵢ is the i^{th} dimension of context.

This intersection is performed dimension by dimension, hence we can write
O¹*∩O²*>=[D¹₁,D¹₂, . . . , D¹ₙ]∩[D²₁,D²₂, . . . ,D²ₙ]
and so,
O¹*∩O²*=[D¹₁∩D²₁,D¹₂∩D²₂, . . . ,D¹ₙ∩D²ₙ]

If any dimension for O¹*∩O²* is the empty set then the dependent object is not viewable through that relationship.

Contextual Information

The contextual information of an item is obtained from not only the direct information of an item, but also other items with which it has a relationship. For example, if item A has a relationship of type Y with item B, then the direct information of A is that it has a relationship of type Y with item B. Item B, in turn, may have a relationship of type X with item C. Full information about item A should include information indicating that item A also has a relationship with item C, albeit through B. In this example, the relationship with item C is indirect information we have about item A. It follows that the contextual information of item A includes both direct and indirect information.

Let us say item A represents the name of a student. The student may have a relationship of type “experience” with item B, which represents “Year 7”. The relationship is a direct one with item B. Accordingly, the direct information of item A is that it has a direct relationship with item B of the type “experience”.

Item B (year 7) may have a relationship of type “equipment” with item C which is “lockers”; that is, students in Year 7 get allocated lockers to store their books in. Item B may also have a type “location” with item D which is “Room 10”.

The relationships amongst the items can be represented as follows:

(student name, experience, Year 7)

(Year 7, equipment, lockers)

(Year 7, location, Room 10)

where (A, Y, B) represents that A has a relationship of type Y with B.

We may only be interested in whether any given student has a locker or not. Accordingly, we require a mechanism to automatically filter the information to provide useful results (ie ignore the third relationship above).

The filtering mechanism determines whether an item is visible to its parent item (or an item of which the item in question is an attribute). It involves calculating the contextual information of the parent item. The contextual information of an item may be calculated recursively as the combination of the items direct information with its childs contextual information. (The word “child” here is used to describe an item linked by a directional relationship.) The childs contextual information may be considered the parents indirect information. This intersection is performed dimension by dimension, as described above. Each child is visible only if none of the dimension intersection operations yields an empty set.

Not all of the other items with which an item has a relationship must be used to determine the items direct or indirect information. The filtering mechanism described above may also be used to filter the relationships which may be used to determine the direct or indirect information of an item.

### EXAMPLES

### Calculation of Contextual Information

### Example 1

Consider a system having two items, A and Y1, related by way of relationship L2. In other words:

Items—A, Y1

Relationships—(A, L2, Y1)

We specify that only the class of relationships L1 may be used to determine the indirect information of an item.

Indirect Information Relationship (IIR)—L1

Note that the relationship is directional ie is directed from A to Y1. Throughout this specification we refer to A as the parent item, and Y1 as the child item, although the relationship between A and Y1 need not be one of parent and child.

The first step of the method of the preferred embodiment is to determine the direct information of the item by identifying one or more of the other items with which the item has a direct relationship. If we are considering the contextual information of item A, the “other item” with which the item has a direct relationship is Y1 (through relationship L2). So the direct information of item A may be expressed as (L2: Y1). This is a structure relating to item Y1. It contains information representing the type of relationship between the items A and Y1 (that is, L2) as well as information representing the identity of the single item (that is, Y1).

The next step of the method involves identifying a class of relationships within the one or more relationships which may be used to determine the indirect information of the item. In this case we have specified that the class of relationships L1 may be used to determine the indirect information of an item.

The indirect information of an item may be determined by determining the contextual information of items with which the item in question, A, has a relationship falling within the previously specified class (ie L1). In this example there are no items which have a relationship with A of the type L1.

Accordingly, the contextual information of item A is simply (L2: Y1).

### Example 2

Consider a system as follows:

Items—A, B, Y1

Relationships—(A, L2, Y1) (B, L1, A)

IIR—L1

The direct information of item A is (L2: Y1) as Y1 is the item of information with which item A has a direct relationship. The direct information of item B is (L1: A). Item Y1 does not have any direct information, as there are no objects with which it has a direct relationship. This information may be summarised as follows:
DI(A)=(L2:Y1)
DI(B)=(L1:A)
DI(Y1)=( )

To determine the indirect information of item A, a determination needs to be made of the contextual information of the items with which item A has a relationship of type L1 (being a relationship of the class used to determine contextual information). A does not have a relationship of type L1 with any other item. Accordingly, the contextual information of item A is the same as its direct information, ie (L2:Y1).

However, item B has a relationship of type L1 with item A. The contextual information of item B is the combination of the direct information of item B with the contextual information of item A, ie (L1:A) combined with (L2:Y1). The contextual information of item A is the indirect information of item B.

In this example, when considering both the direct and indirect information of item B, there is only one item for each relationship type. When combining the direct and indirect information of item B in this example, we calculate the intersection of the items associated with each relationship. Where the items are nodes in a directed acyclic graph, the result of the intersection operation is the most specific node in each branch associated with the relationship.

The direct information of item B (L1:A) does not share a relationship with the contextual information of item A (L2:Y1). Accordingly, we can simply express the contextual information of item B as {(L1:A) (L2:Y1)}.

In this example, item A might be Year 7, item B might be John and item Y1 might be Room 10. L2 is the relationship “location” and L1 is “experience”. In other words:

Relationships—(Year 7, location, Room 10) (John, experience, Year 7)

IIR—experience
DI(Year 7)=(L2:Y1)=(location: Room 10)
DI(John)=(L1:A)=(experience: Year 7)
DI(Y1)=( )

As we are only interested in “experience” to provide any indirect information, the contextual information of Year 7 (item A) is (location: Room 10) ie (L2:Y1). The contextual information of John (item B) is, as indicated above, {(L1:A) (L2:Y1)} or {(experience: Year 7) (location: Room 10)}.

If, alternatively, we had selected L2 as the type of relationship to provide indirect information, the contextual information of item A could not be used in the determination of the contextual information of item B (as item A and item B are linked by relationship L1 and not L2). Accordingly when considering item B (ie John) the fact that John has the experience of Year 7 is visible, but the fact that Year 7 is in Room 10 is invisible.

Components of Direct Information

In the examples above, direct information is determined simply by identifying one or more of the items with which the item in question has a direct relationship. However, in some circumstances (for example, where you wish to treat relationships as equivalent to each other) direct information can be expanded to include items which do not have a direct relationship with the item in question, but are linked by a specified type of relationship to items which do have a direct relationship with the item in question.

This specification of relationships which can be used to determine direct information (specifically, second information) enables classification of information via one taxonomy while allowing discovery of the information through another taxonomy (which specifies different relationships to be used to calculate second information).

### Example

### Calculation of First and Second Information

Consider a system as follows:

Objects:

A, B, Y1, Z1

Relationships:

(B, L1, A)

(A, L2, Y1)

(Y1, L3, Z1)

Relationship Class or Type for Determining Indirect Information (IIR)

L1

Relationship Classes or Types for Determining Second Information (SIR)

L2->L3

In this system relationship L2 is a first type of relationship and relationship L3 is a second type of relationship. The notation “L2->L3” indicates a correspondence specified between L2 and L3.

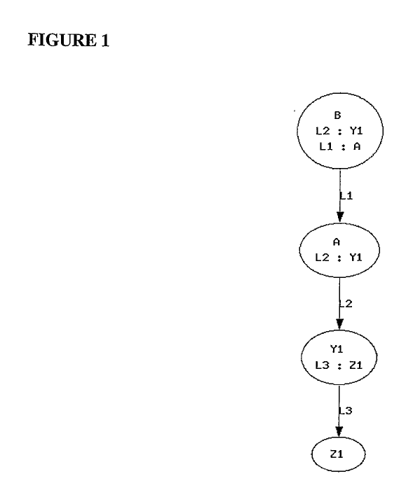

FIG. 1 is an illustration of the items and relationships.

To calculate the direct information of an item, the first and second information of the item must be calculated and then combined.

Considering item A, the first information relating to item A is the one or more items with which item A has a relationship of any type. A has a relationship L2 with Y1, so the first information is (L2: Y1). To determine the second information, items that need to be identified are those which have a relationship of the second type with items which have a relationship with item A of the first type. In other words, items which have a relationship of type L3 with items which have a relationship of type L2 with item A. Y1 has a relationship of type L2 with item A. Z1 has a relationship of type L3 with Y1. So Z1 has a relationship with Y1 of type L3, and Y1 has a relationship of type L2 with A. So Z1 forms part of the second information, expressed as (L3: Z1) (L3 being the relationship by which Z1 is linked to Y1).

To calculate the direct information of A, the first and second information must be combined. As the first and second information do not contain multiple items relating to a single relationship type, the combination is simply {(L2:Y1) (L3:Z1)}.

The indirect information of item A is the contextual information of items which are related to item A through a relationship of type L1. As there are no such items of information, the contextual information of item A is the same as its direct information, ie {(L2:Y1) (L3:Z1)}.

Considering now item B, the first information relating to item B is the one or more items with which item B has a relationship of any type, ie (L1:A). There are no items which are linked to item B by the first type of relationship L2, so item B does not have any second information. The direct information of item B is therefore its first information, ie (L1:A).

To calculate the contextual information of item B, item Bs direct and indirect information must be combined. The direct information of item B is (L1:A). The indirect information of item B is the contextual information of the items which relate to item B through a relationship of type L1, in this example item A. The contextual information of item A is calculated above as {(L2:Y1) (L3:Z1)}. As the direct and indirect information of item B, when considered as a whole, has a single item associated with each relationship, the contextual information of item B is simply a combination of the relationships ie {(L1:A) (L2:Y1) (L3:Z1)}.

### Example

### Profile Driven Application

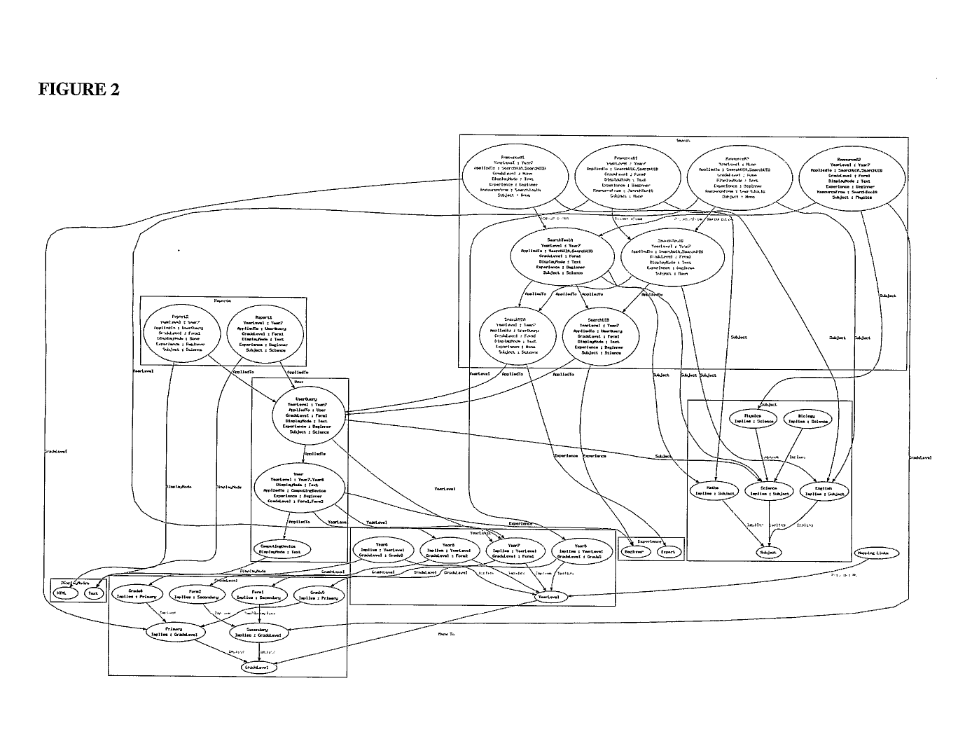

In this example we will consider a model of an educational application for resource discovery and reporting. FIG. 2 is an illustration of the model including representations of items and relationships.

It has been split into a number of different sections. These represent different functional areas of the application:

User

This area contains all the profile information relating to a particular user, and a specific search (query) they are running in the application. In this example the profile is built from the details of the user (User) the particular query they are running (UserQuery) as well as what sort of device they are using to run the query (ComputingDevice). The user in this case is represented as a Year 7 & 8 Teacher or Student who is a beginner user of the system. The query they run is specified as finding Science resources for Year7. ComputingDevice is a simple item representing the hardware capabilities of the device the user is using to access the system. In this case the device is represented as text only capable which could indicate a low bandwidth connected device with a simple text-based display.

YearLevel, GradeLevel, Subject, DisplayModes, Experience

These represent the different taxonomies used within the application. The first three are specific to the educational domain, while the last two are more generic. A mapping via GradeLevel links exists between the YearLevel and GradeLevel taxonomies. These two taxonomies represent two different subsets of classification systems used to describe what level a student is in at school.

Reports

This area contains the report items which can be used to display results obtained from the users query. These reports are classified in this example by the type of output they give (DisplayMode) and in this example one provides results in HTML format, the other in plain text.

Search

This area contains three main types of objects.
Search User Interfaces (SearchUI*) are items that that describe a user interface for the user to perform a search through. This example has two SearchULIs with one representing a basic interface, and the other a more advanced, or expert interface.
Search Tools (SearchTool*) represent configurations for different sources of resources. These tools could range from a configuration that connects to the local system, to an interface to a relational database, to a configuration for connecting to a web service that allows searching.
Search Results (Resource*) represent a few possible results that are associated in this case with specific Search Tools. These are representative of a resource that a user may find and use such as a web page, an image, a document etc.

The results for the items of interest are as follows:

Items—First Information

| | |
|---|---|
| ResourceA1 | {(ResourceFrom: SearchToolA) (GradeLevel: Primary) (Subject: Maths)} |
| ResourceA2 | {(ResourceFrom: SearchToolA) (GradeLevel: Secondary) (Subject: Physics)} |
| ResourceB1 | {(ResourceFrom: SearchToolB) (YearLevel: Year7) (Subject: English)} |
| ResourceB2 | {(ResourceFrom: SearchToolB) (YearLevel: Year5) (Subject: English)} |
| SearchToolA | {(AppliedTo: [SearchUIA, SearchUIB]) (Subject: [Maths, Science])} |
| SearchToolB | {(AppliedTo: [SearchUIA, SearchUIB]) (Subject: English)} |
| SearchUIA | {(AppliedTo: UserQuery) (Experience: Expert)} |
| SearchUIB | {(AppliedTo: UserQuery) (Experience: Beginner)} |
| Report1 | {(DisplayMode: Text) (AppliedTo: UserQuery)} |
| Report2 | {(DisplayMode: HTML) (AppliedTo: UserQuery)} |
| UserQuery | {(YearLevel: Year7) (AppliedTo: User) (Subject: Science)} |
| User | {(YearLevel: [Year7, Year8]) (AppliedTo: ComputingDevice) (Experience: Beginner)} |
| ComputingDevice | {(DisplayMode: Text)} |

Items—Direct Information:

| | |
|---|---|
| ResourceA1 | {(ResourceFrom: SearchToolA) (GradeLevel: Primary) (Subject: Maths)} |
| ResourceA2 | {(ResourceFrom: SearchToolA) (GradeLevel: Secondary) (Subject: Physics)} |
| ResourceB1 | {(ResourceFrom: SearchToolB) (YearLevel: Year7) (Subject: English) (GradeLevel: Form1)} |
| ResourceB2 | {(ResourceFrom: SearchToolB) (YearLevel: Year5) (Subject: English) (GradeLevel: Grade5)} |
| SearchToolA | {(AppliedTo: [SearchUIA, SearchUIB]) (Subject: [Maths, Science])} |
| SearchToolB | {(AppliedTo: [SearchUIA, SearchUIB]) (Subject: English)} |
| SearchUIA | {(AppliedTo: UserQuery) (Experience: Expert)} |
| SearchUIB | {(AppliedTo: UserQuery) (Experience: Beginner)} |
| Report1 | {(DisplayMode: Text) (AppliedTo: UserQuery)} |
| Report2 | {(DisplayMode: HTML) (AppliedTo: UserQuery)} |
| UserQuery | {(YearLevel: Year7) (Subject: Science) (AppliedTo: User) (GradeLevel: Form1)} |
| User | {(YearLevel: [Year7, Year8]) (AppliedTo: ComputingDevice) (Experience: Beginner) |
| | (GradeLevel: [Form1, Form2])} |
| ComputingDevice | {(DisplayMode: Text)} |

Calculation of Direct Information

The diagram indicates that the relationship “YearLevel” corresponds with relationship “GradeLevel”. In other words, the relationship “YearLevel” is a first type of relationship, and relationship “GradeLevel” is a second type of relationship.

Considering the item of information “ResourceB1”, it has the following direct relationships:

(ResourceB1, ResourceFrom, SearchToolB)

(ResourceB1, YearLevel, Year7)

(ResourceB1, Subject, English)

Accordingly, the first information of ResourceB1 is {(ResourceFrom: SearchToolB) (YearLevel: Year7) (Subject: English)}.

The item Year 7 is in the relationship (Year7, GradeLevel, Form 1). It follows that Form 1 is in a relationship of the second type with an item of information (Year7) which is in a relationship of the first type with ResourceB1. Accordingly, the second information of ResourceB1 is (GradeLevel: Form1).

The direct information of ResourceB1 is the combination of the first and second information, ie {(ResourceFrom: SearchToolB) (YearLevel: Year7) (Subject: English) (GradeLevel: Form1)}.

Items—Contextual Information:

| | |
|---|---|
| ResourceA1 | {(YearLevel: Year7) (AppliedTo: [SearchUIA, SearchUIB]) (GradeLevel: None) (DisplayMode: Text) |
| | (Experience: Beginner) (ResourceFrom: SearchToolA) (Subject: None)} |
| ResourceA2 | {(YearLevel: Year7) (AppliedTo: [SearchUIA, SearchUIB]) (GradeLevel: Form1) (DisplayMode: Text) |
| | (Experience: Beginner) (ResourceFrom: SearchToolA) (Subject: Physics)} |
| ResourceB1 | {(YearLevel: Year7) (AppliedTo: [SearchUIA, SearchUIB]) (GradeLevel: Form1) (DisplayMode: Text) |
| | (Experience: Beginner) (ResourceFrom: SearchToolB) (Subject: None)} |
| ResourceB2 | {(YearLevel: None) (AppliedTo: [SearchUIA, SearchUIB]) (GradeLevel: None) (DisplayMode: Text) |
| | (Experience: Beginner) (ResourceFrom: SearchToolB) (Subject: None)} |
| SearchToolA | {(YearLevel: Year7) (AppliedTo: [SearchUIA, SearchUIB]) (GradeLevel: Form1) (DisplayMode: Text) |
| | (Experience: Beginner) (Subject: Science)} |
| SearchToolB | {(YearLevel: Year7) (AppliedTo: [SearchUIA, SearchUIB]) (GradeLevel: Form1) (DisplayMode: Text) |
| | (Experience: Beginner) (Subject: None)} |
| SearchUIA | {(YearLevel: Year7) (AppliedTo: UserQuery) (GradeLevel: Form1) (DisplayMode: Text) (Experience: None) |
| | (Subject: Science)} |
| SearchUIB | {(YearLevel: Year7) (AppliedTo: UserQuery) (GradeLevel: Form1) (DisplayMode: Text) (Experience: Beginner) |
| | (Subject: Science)} |
| Report1 | {(YearLevel: Year7) (AppliedTo: UserQuery) (GradeLevel: Form1) (DisplayMode: Text) (Experience: Beginner) |
| | (Subject: Science)} |
| Report2 | {(YearLevel: Year7) (AppliedTo: UserQuery) (GradeLevel: Form1) (DisplayMode: None) (Experience: |
| | Beginner) (Subject: Science)} |
| UserQuery | {(YearLevel: Year7) (AppliedTo: User) (GradeLevel: Form1) (DisplayMode: Text) (Experience: Beginner) |
| | (Subject: Science)} |
| User | {(YearLevel: [Year7, Year8]) (DisplayMode: Text) (AppliedTo: ComputingDevice) (Experience: Beginner) |
| | (GradeLevel: [Form1, Form2])} |
| ComputingDevice | {(DisplayMode: Text)} |

Considering again ResourceB1, we have determined above that its direct information is {(ResourceFrom: SearchToolB) (YearLevel: Year7) (Subject: English) (GradeLevel: Form1)}. Its indirect information is the combination of the contextual information of those items with which it has a relationship falling within an identified class or of a specified type. The types of relationships which may be used to determine the indirect information of items are the relationships “AppliedTo”, “ResourceFrom” and “Implies”.

As indicated above, ResourceB1 has a relationship “ResourceFrom” with SearchToolB. So the contextual information of SearchToolB is the indirect information of ResourceB1.

The contextual information of SearchToolB can be calculated to be: {(YearLevel: Year7) (AppliedTo: SearchUIA) (AppliedTo: SearchUIB) (GradeLevel: Form1) (DisplayMode: Text) (Experience: Beginner) (Subject: None)}.

The contextual information of ResourceB1 is a combination of its direct and indirect information. To combine the direct and indirect information, we calculate the intersection of each set of items associated with each relationship. Each relationship, along with its related items, may be listed:

YearLevel: Year7, Year7=Year 7 (when combined)

AppliedTo: Search UIA, SearchUIB=SearchUIA, SearchUIB (when combined)

GradeLevel: Form1, Form1=Form 1 (when combined)

DisplayMode: Text

Experience: Beginner

ResourceFrom: SearchToolB

Subject: English, None=None (when combined)

So the contextual information of ResourceB1 is {(YearLevel: Year7) (AppliedTo:[SearchUIA, SearchUIB]) (GradeLevel: Form1) (DisplayMode: Text) (Experience: Beginner) (ResourceFrom: SearchToolB) (Subject: None)}.

The results of the users query are the result items that are “in context”, that is, are visible to the UserQuery item. As indicated earlier, an item is visible only if none of its dimension intersection operations yields an empty set. The relationship “Subject” does not have an associated item. Accordingly, this item is not “viewable” from ResourceB1, and accordingly is not the result of the query.

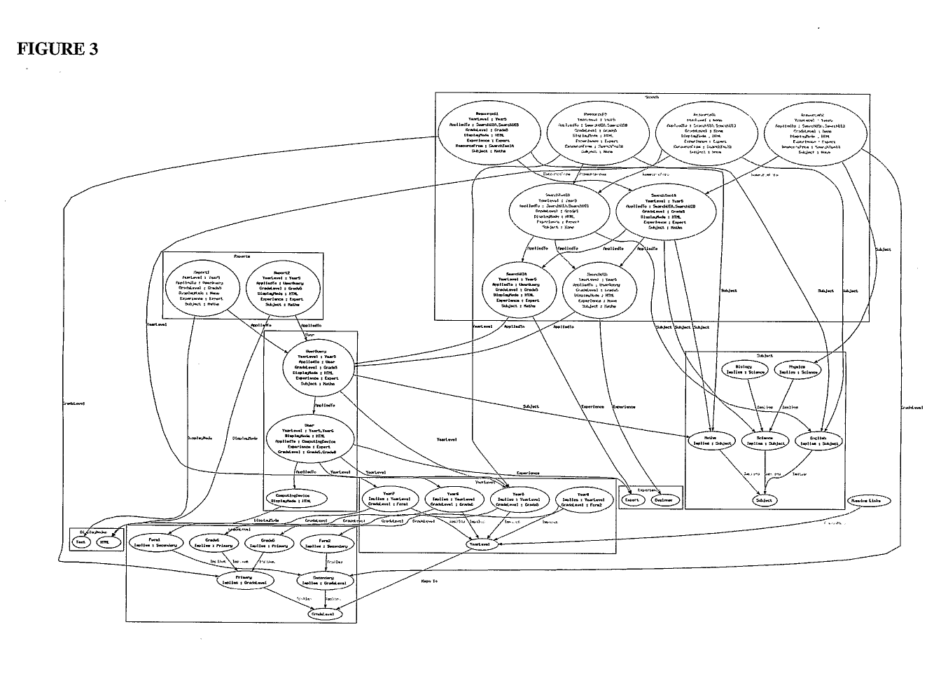

FIG. 3 illustrates the same system queried by a different user. The items of information within the “user” area differ from those illustrated in FIG. 2. The relationships in the system are:

(User, Experience, Expert)

(User, YearLevel, Year5)

(User, YearLevel, Year6)

(ComputingDevice, DisplayMode, HTML)

(UserQuery, Subject, Maths)

(UserQuery, YearLevel, Year5)

(User, AppliedTo, ComputingDevice)

(UserQuery, AppliedTo, User)

(SearchUIA, AppliedTo, UserQuery)

(SearchUIB, AppliedTo, UserQuery)

(SearchToolA, AppliedTo, SearchUIA)

(SearchToolA, AppliedTo, SearchUIB)

(SearchToolB, AppliedTo, SearchUIA)

(SearchToolB, AppliedTo, SearchUIB)

(ResourceA1, ResourceFrom, SearchToolA)

(ResourceA2, ResourceFrom, SearchToolA)

(ResourceB1, ResourceFrom, SearchToolB)

(ResourceB2, ResourceFrom, SearchToolB)

(Report1, AppliedTo, UserQuery)

(Report2, AppliedTo, UserQuery)

(SearchToolA, Subject, Maths)

(SearchToolA, Subject, Science)

(ResourceA1, Subject, Maths)

(ResourceA1, GradeLevel, Primary)

(ResourceA2, Subject, Physics)

(ResourceA2, GradeLevel, Secondary)

(SearchToolB, Subject, English)

(ResourceB1, Subject, English)

(ResourceB1, YearLevel, Year7)

(ResourceB2, Subject, English)

(ResourceB2, YearLevel, Year5)

(SearchUIA, Experience, Expert)

(SearchUIB, Experience, Beginner)

(Report1, DisplayMode, Text)

(Report2, DisplayMode, HTML)

(Maths, Implies, Subject)

(English, Implies, Subject)

(Science, Implies, Subject)

(Physics, Implies, Science)

(Biology, Implies, Science)

(Year5, Implies, YearLevel)

(Year6, Implies, YearLevel)

(Year7, Implies, YearLevel)

(Year8, Implies, YearLevel)

(Primary, Implies, GradeLevel)

(Secondary, Implies, GradeLevel)

(Grade5, Implies, Primary)

(Grade6, Implies, Primary)

(Form1, Implies, Secondary)

(Form2, Implies, Secondary)

(Year5, GradeLevel, Grade5)

(Year6, GradeLevel, Grade6)

(Year7, GradeLevel, Form1)

(Year8, GradeLevel, Form2)

Results of calculations determining the first information, second information and direct information are as follows:

Items—First information

| | |
|---|---|
| ResourceA1 | {(ResourceFrom: SearchToolA) (GradeLevel: Primary) (Subject: Maths)} |
| ResourceA2 | {(ResourceFrom: SearchToolA) (GradeLevel: Secondary) (Subject: Physics)} |
| ResourceB1 | {(ResourceFrom: SearchToolB) (YearLevel: Year7) (Subject: English)} |
| ResourceB2 | {(ResourceFrom: SearchToolB) (YearLevel: Year5) (Subject: English)} |
| SearchToolA | {(AppliedTo: [SearchUIA, SearchUIB]) (Subject: [Maths, Science])} |
| SearchToolB | {(AppliedTo: [SearchUIA, SearchUIB]) (Subject: English)} |
| SearchUIA | {(AppliedTo: UserQuery) (Experience: Expert)} |
| SearchUIB | {(AppliedTo: UserQuery) (Experience: Beginner)} |
| Report1 | {(DisplayMode: Text) (AppliedTo: UserQuery)} |
| Report2 | {(DisplayMode: HTML) (AppliedTo: UserQuery)} |
| UserQuery | {(YearLevel: Year5) (AppliedTo: User) (Subject: Maths)} |
| User | {(YearLevel: Year5) (YearLevel: Year6) (AppliedTo: ComputingDevice) (Experience: Expert)} |
| ComputingDevice | {(DisplayMode: HTML)} |

Items—Direct Information:

| | |
|---|---|
| ResourceA1 | {(ResourceFrom: SearchToolA) (GradeLevel: Primary) (Subject: Maths)} |
| ResourceA2 | {(ResourceFrom: SearchToolA) (GradeLevel: Secondary) (Subject: Physics)} |
| ResourceB1 | {(ResourceFrom: SearchToolB) (YearLevel: Year7) (Subject: English) (GradeLevel: Form1)} |
| ResourceB2 | {(ResourceFrom: SearchToolB) (YearLevel: Year5) (Subject: English) (GradeLevel: Grade5)} |
| SearchToolA | {(AppliedTo: [SearchUIA, SearchUIB]) (Subject: [Maths, Science])} |
| SearchToolB | {(AppliedTo: [SearchUIA, SearchUIB]) (Subject: English)} |
| SearchUIA | {(AppliedTo: UserQuery) (Experience: Expert)} |
| SearchUIB | {(AppliedTo: UserQuery) (Experience: Beginner)} |
| Report1 | {(DisplayMode: Text) (AppliedTo: UserQuery)} |
| Report2 | {(DisplayMode: HTML) (AppliedTo: UserQuery)} |
| UserQuery | {(YearLevel: Year5) (Subject: Maths) (AppliedTo: User) (GradeLevel: Grade5)} |
| User | {(YearLevel: [Year5, Year6]) (AppliedTo: ComputingDevice) (Experience: Expert) (GradeLevel: |
| | [Grade5, Grade6])} |
| ComputingDevice | {(DisplayMode: HTML)} |

Items—Contextual Information:

| | |
|---|---|
| ResourceA1 | {(YearLevel: Year5) (AppliedTo: [SearchUIA, SearchUIB]) (GradeLevel: Grade5) (DisplayMode: HTML) |
| | (Experience: Expert) (ResourceFrom: SearchToolA) (Subject: Maths)} |
| ResourceA2 | {(YearLevel: Year5) (AppliedTo: [SearchUIA, SearchUIB]) (GradeLevel: None) (DisplayMode: HTML) |
| | (Experience: Expert) (ResourceFrom: SearchToolA) (Subject: None)} |
| ResourceB1 | {(YearLevel: None) (AppliedTo: [SearchUIA, SearchUIB]) (GradeLevel: None) (DisplayMode: HTML) |
| | (Experience: Expert) (ResourceFrom: SearchToolB) (Subject: None)} |
| ResourceB2 | {(YearLevel: Year5) (AppliedTo: [SearchUIA, SearchUIB]) (GradeLevel: Grade5) (DisplayMode: HTML) |
| | (Experience: Expert) (ResourceFrom: SearchToolB) (Subject: None)} |
| SearchToolA | {(YearLevel: Year5) (AppliedTo: [SearchUIA, SearchUIB]) (GradeLevel: Grade5) (DisplayMode: HTML) |
| | (Experience: Expert) (Subject: Maths)} |
| SearchToolB | {(YearLevel: Year5) (AppliedTo: [SearchUIA, SearchUIB]) (GradeLevel: Grade5) (DisplayMode: HTML) |
| | (Experience: Expert) (Subject: None)} |
| SearchUIA | {(YearLevel: Year5) (AppliedTo: UserQuery) (GradeLevel: Grade5) (DisplayMode: HTML) (Experience: Expert) |
| | (Subject: Maths)} |
| SearchUIB | {(YearLevel: Year5) (AppliedTo: UserQuery) (GradeLevel: Grade5) (DisplayMode: HTML) (Experience: None) |
| | (Subject: Maths)} |
| Report1 | {(YearLevel: Year5) (AppliedTo: UserQuery) (GradeLevel: Grade5) (DisplayMode: None) (Experience: Expert) |
| | (Subject: Maths)} |
| Report2 | {(YearLevel: Year5) (AppliedTo: UserQuery) (GradeLevel: Grade5) (DisplayMode: HTML) (Experience: Expert) |
| | (Subject: Maths)} |
| UserQuery | {(YearLevel: Year5) (AppliedTo: User) (GradeLevel: Grade5) (DisplayMode: HTML) (Experience: Expert) |
| | (Subject: Maths)} |
| User | {(YearLevel: [Year5, Year6]) (DisplayMode: HTML) (AppliedTo: ComputingDevice) (Experience: Expert) |
| | (GradeLevel: [Grade5, Grade6])} |
| ComputingDevice | {(DisplayMode: HTML)} |

Combining Operations

In the previous examples an intersection operation has been used to combine the direct and indirect information about an item. However the nature of the combining operation is dependent on the nature of the interpretation of items comprising the direct and indirect information. For example, if items represent parts of a book, with different parts of the book contained within each other, a union operation may be more appropriate than an intersection operation.

Consider a book containing a number of nested sections—P1, P1.1 and P1.1.1. P1.1.1 is contained within p1.1, which is in turn contained within P1. Each section may contain keywords, for example Maths, Stats and Probability.

The items in the system would therefore be: P1, P1.1, P1.1.1, Maths, Statistics and Probability. In the book, the items have the following relationships:

P1.1.1 is contained within P1.1→(P1.1.1, ContainedWithin, P1.1)

P1.1 is contained with P1→(P1.1, ContainedWithin, P1)

P1 contains the keyword “Maths”+(P1, Keyword, Maths)

P1.1 contains the keyword “Stats”→(P1.1, Keyword, Stats)

P1.1.1 contains the keyword Probability→(P1.1.1, Keyword, Probability)

The relationship which connects the items we are interested in, and which can provide further information about the sections of the book, is the ContainedWithin relationship. This relationship is therefore the relationship which may be used to determine the indirect information of the items.

We would like to determine the keywords associated with each chapter of the book, and ultimately it is the keywords which will be the contextual information which we wish to calculate. In this example, the appropriate operation combining the direct and indirect information is the union operation, as we wish to know all of the keywords associated with a specific chapter. The Keyword relationship is also therefore the most appropriate relationship to use to determine the direct information about any of the items.

Direct Information

The direct information of the relevant items is as follows:
DI(P1)=(Keyword: Maths)
DI(P1.1)=(Keyword: Stats) (note that the relationship (ContainedWithin: P1) does not appear here as we are only using the Keyword relationship to determine the direct information of the item)
DI(P1.1.1)=(Keyword:Probability)
Contextual Information

$$Ctx ( P 1 ) = DI ( P 1 ) combined with Ctx ( ) = DI ( P 1 ) union with ( ) = DI ( PI ) = ( Keyword \text{:} Maths ) \\ Ctx ( P 1.1 ) = DI ( P 1.1 ) union Ctx ( P 1 ) = ( Keyword \text{:} Stats ) union ( Keyword \text{:} Maths ) = ( Keyword \text{:} ( Maths , Stats ) ) \\ Ctx ( P 1.1 .1 ) = DI ( P 1.1 .1 ) union Ctx ( P 1.1 ) = ( Keyword \text{:} Probability ) union ( Keyword \text{:} Maths , Stats ) ) = ( Keyword \text{:} ( Maths , Stats , Probability ) )$$

Combining Operations and Different Users

Consider the items and relationships of the previous example, together with additional items of information representing revision data. The revision data is associated with different sections of the book. Consider also the use of the keyword identification system by different users—Joe Smith, who is simply an end-user of the system, and Mark Jones, who is an editor of the system.

Because Mark Jones and Joe Smith are different types of users of the system, the relationships which will be relevant to each of them may be different. The relationships will depend on the type of the user—the relationships relevant to an end-user will be different to those that are relevant to an editor of the system.

To accommodate the addition of revision data and the calculation of relevant relationships for each user, additional items are introduced:

Additional items—RevisionData, Editor, EndUser

Additional relationships (items)—UserType, RevisionRelation, DirectInfoRelationship

Additional relationship (not item in this example)—AppliedTo

The first calculation that needs to be made is the direct information relationship relevant to the user. The calculation of the direct information relationship involves the use of the preferred embodiment of the invention ie the calculation of the contextual information of a relationship (the relationship being an “item”). The set of potential direct information relationships are the newly introduced RevisionRelation relationship, or could be the Keyword relationship:

(RevisionRelation, AppliedTo, DirectInfoRelationship)

(Keyword, AppliedTo, DirectInfoRelationship)

The RevisionRelation relationship should only be accessible to editors, while the Keyword relationship should be accessible to all users:

(RevisionRelation, UserType, Editor)

(Keyword, UserType, Editor)

(Keyword, UserType, EndUser)

Editor and EndUser are both types of users:

(Editor, AppliedTo, EndUser)

(EndUser, AppliedTo, EndUser)

You will see from the above that the AppliedTo relationship defines a characteristic of an item—an Editor is an EndUser, and RevisionRelation is a type of DirectInfoRelationship. As such, it may be specified as the relationship type which may be used to determine the indirect information of the item in question. The selection of the relationship which can be used to determine the direct information of the item is determined by the type of user ie UserType.

Joe Smith

Joe Smith is an end-user of the system+(JoeSmith, UserType, EndUser)
We want to find out which DirectInfoRelationship is applicable to JoeSmith→(DirectInfoRelationship, AppliedTo, JoeSmith)

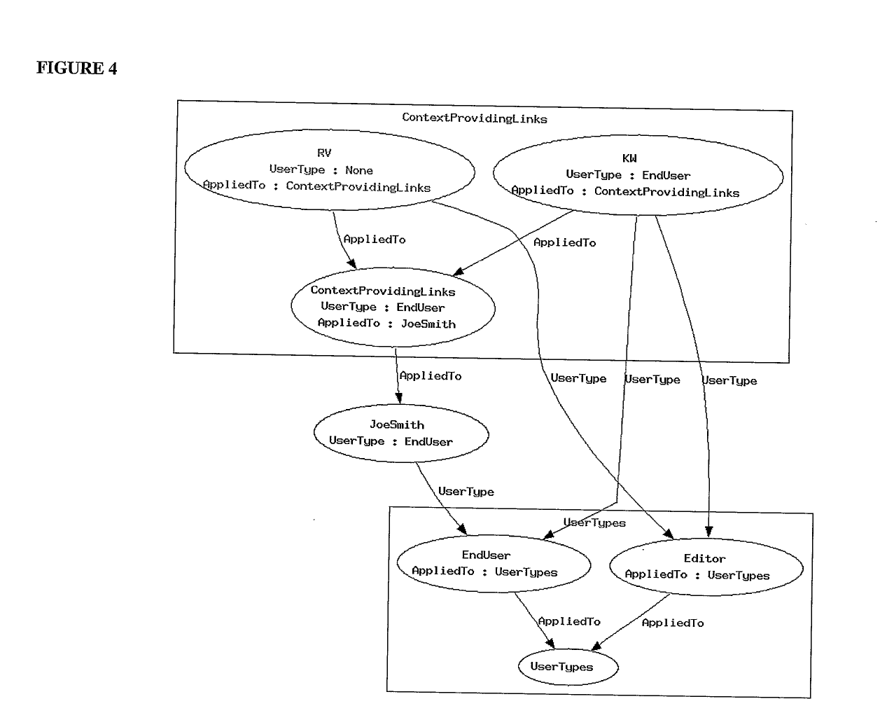

FIG. 4 illustrates the items and relationships applicable to Joe Smith in the calculation of the relationship which can be used to determine the direct information of items.

As indicated above, in determining the direct information of the items, the UserType relationship is the relevant relationship:
DI(UserTypes)=( )
DI(EndUser)=( )
DI(Editor)=( )
DI(JoeSmith)=(UserType: EndUser)
DI(Keyword)=(UserType: Editor) (UserType: EndUser)
DI(RevisionRelation)=(UserType: Editor)
DI(DirectInfoRelationship)=( )

To determine the indirect information of the items, the AppliedTo relationship is the relevant relationship:

$$Ctx ( UserTypes ) = DI ( UserTypes ) ⋂ ( ) = ( )$$

$$Ctx ( EndUser ) = DI ( EndUser ) ⋂ Ctx ( UserTypes ) = ( )$$

$$Ctx ( Editor ) = DI ( Editor ) ⋂ Ctx ( UserTypes ) = ( )$$

$$Ctx ( JoeSmith ) = DI ( JoeSmith ) ⋂ ( ) = ( UserType \text{:} EndUser )$$

$$Ctx ( DirectInfoRelationship ) = DI ( DirectInfoRelationship ) ⋂ Ctx ( JoeSmith ) = ( ) ⋂ ( UserType \text{:} EndUser ) = ( UserType \text{:} EndUser )$$

$$Ctx ( Keyword ) = DI ( Keyword ) ⋂ Ctx ( DirectInfoRelationship ) = ( UserType \text{:} ( Editor , EndUser ) ) ⋂ ( UserTyp \text{:} EndUser ) = ( USerType \text{:} EndUser )$$

$$Ctx ( RevisionRelation ) = DI ( RevisionRelation ) ⋂ Ctx ( DirectImfoRelationship ) = ( UserType \text{:} Editor ) ⋂ ( UserType \text{:} EndUser ) = ( )$$

The calculations result in the item RevisionRelation not being visible, as it does not have any contextual information. However, the Keyword item is visible. This means that for Joe Smith, the Keyword relationship is the relationship that may be used to determine the direct information of items.

Mark Jones

Consider now Mark Jones, editor:

(MarkJones, UserType, Editor)

(DirectInfoRelationship, AppliedTo, MarkJones)

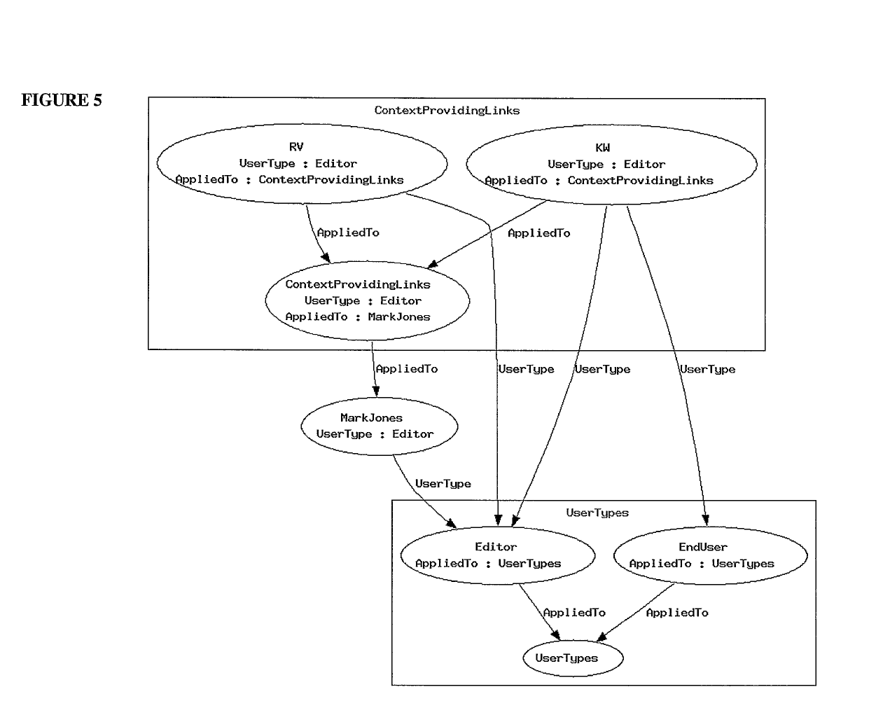

FIG. 5 illustrates the items and relationships applicable to Mark Jones in the calculation of the relationship which can be used to determine the direct information of items. The following calculations differs from those set out above in relation to JoeSmith:

$$DI ( MarkJones ) = ( UserType \text{:} Editor )$$

$$Ctx ( MarkJones ) = DI ( MarkJones ) ⋂ ( ) = ( UserType \text{:} Editor )$$

$$Ctx ( DirectInfoRelationship ) = ( DI ( DirectInfoRelationship ) ⋂ Ctx ( MarkJones ) = ( ) ⋂ ( UserType \text{:} Editor ) = ( UserType \text{:} Editor ) \\ Ctx ( RevisionRelation ) = DI ( RevisionRelation ) ⋂ Ctx ( DirectInfoRelationship ) = ( UserType \text{:} Editor ) ⋂ ( UserTypeEditor ) = ( Usertype \text{:} Editor )$$

From these calculations it is clear that both the Keyword and RevisionRelation relationships are viewable. Accordingly, both relationships are able to be used by Mark Jones.

The System

As indicated earlier, Joe Smith and Mark Jones are both users of a system that identifies keywords in sections of a book (as with the previous example). As with the previous example, the following relationships exist:

P1.1.1 is contained within P1.1→(P1.1.1, ContainedWithin, P1.1)

P1.1 is contained with P1→(P1.1, ContainedWithin, P1)

P1 contains the keyword “Maths”→(P1, Keyword, Maths)

P1.1 contains the keyword “Stats”→(P1.1, Keyword, Stats)

P1.1.1 contains the keyword Probability→(P1.1.1, Keyword, Probability)

Each of the chapters is also associated with revision data, so:

(P1, RevisionRelation, RevisionData1)

(P2, RevisionRelation, RevisionData2)

(P3, RevisionRelation, RevisionData3).

As with the earlier example, additional information about a chapter is obtained through the ContainedWithin relationship, so this is the relationship which used to determine the indirect information of an item.

The System as Seen by Joe Smith

It has been calculated earlier that the relationship which may be used by Joe Smith to determine direct information of items is the Keyword relationship.
DI(P1)=(Keyword: Maths)
DI(P1.1)=(Keyword: Stats)
DI(P1.1.1)=(Keyword: Probability)
DI(Maths)=( )
DI(Stats)=( )
DI(Probability)=( )
DI(RevisionData1)=( )
DI(RevisionData2)=( )
DI(RevisionData3)=( )

$$Ctx ( P 1 ) = DI ( P 1 ) combined with ( ) = ( Keyword \text{:} Maths ) \\ Ctx ( P 1.1 ) = DI ( P 1.1 ) combined with Ctx ( P 1 ) = ( Keyword \text{:} Stats ) combined with ( Keyword \text{:} Maths ) = ( Keyword \text{:} ( Stats , Maths ) ) \\ Ctx ( P 1.1 .1 ) = DI ( P 1.1 .1 ) combined with Ctx ( P 1.1 ) = ( Keyword \text{:} Probability ) combined with ( Keyword \text{:} Stats , Maths ) ) = ( Keyword \text{:} ( Probability , Stats , Maths ) )$$

These calculations demonstrate that Joe Smith is able to see each of the keywords associated with the various sections of the book.

The system as seen by Mark Jones

It has been calculated earlier that the relationships which may be used by Mark Jones to determine direct information of items are the Keyword and RevisionRelation relationships.
DI(P1)=(Keyword: Maths) (RevisionRelation: RevisionData1)
DI(P1.1)=(Keyword: Stats) (RevisionRelation: RevisionData2)
DI(P1.1.1)=(Keyword: Probability) (RevisionRelation: RevisionData3)
DI(Maths)=( )
DI(Stats)=( )
DI(Probability)=( )
DI(RevisionData1)=( )
DI(RevisionData2)=( )
DI(RevisionData3)=( )

$$Ctx ( P 1 ) = DI ( P 1 ) combined with ( ) = ( Keyword \text{:} Maths ) ( RevisionRelation \text{:} RevisionData 1 )$$

$$Ctx ( P 1.1 ) = DI ( P 1.1 ) combined with Ctx ( P 1 ) = \{ ( Keyword \text{:} Stats ) ( RevisionRelation \text{:} RevisionData 2 ) \} combined with \{ ( Keyword \text{:} Maths ) ( RevisionRelation \text{:} RevisionData 1 ) \} = \{ ( Keyword \text{:} ( Stats , Maths ) ) ( RevisionRelation \text{:} ( RevisionData 1 , RevisionData 2 ) ) \}$$

$$Ctx ( P 1.1 .1 ) - DI ( P 1.1 .1 ) combined with Ctx ( P 1.1 ) = \{ ( Keyword \text{:} Probability ) ( RevisionRelation \text{:} RevisionData 3 ) \} combined with \{ ( Keyword \text{:} ( Stats , Maths ) ) ( RevisionRelation \text{:} ( RevisionData 1 , RevisionData 2 ) ) \} = \{ ( Keyword \text{:} ( Stats , Maths , Probability ) ) ( RevisionRelation \text{:} ( RevisionData 1 , RevisionData 2 , RevisionData 3 ) ) \}$$

These calculations show that for Mark Jones, editor, additional information is available (specifically in this example revision information).

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for determining contextual information of an item which has one or more relationships with other items, the method comprising the steps of:
determining direct information of the item by identifying one or more of the other items with which the item has a direct relationship;
identifying a class of relationships within the one or more relationships to determine indirect information of the item;
determining the indirect information of the item by determining contextual information of said one or more items with which the item has a relationship falling within the class of relationships; and
combining the direct information and the indirect information to determine the contextual information.

2. A method as claimed in claim 1 wherein said direct relationship is selected from a set of potential relationships.

3. A method as claimed in claim 2 wherein the selection of a direct relationship includes the step of determining the contextual information of the relationships in the set of potential relationships.

4. A method is claimed in claim 1 wherein the relationships comprise two or more different types of relationship.

5. A method as claimed in claim 4 wherein the step of identifying a class of relationships within the one or more relationships includes the step of determining the contextual information of each type of relationship.

6. A method as claimed in claim 1 further including the step of specifying a correspondence between a first and second type of relationship of the one or more relationships, the step of determining direct information including the steps of
determining first information by identifying one or more of the other items with which the item has a direct relationship of any type;
determining second information by identifying one or more of the other items which have a relationship of the second type with items which are related to the item by a relationship of the first type; and
combining the first and second information.

7. A method as claimed in claim 1 wherein the step of determining direct information of the item includes assembling a plurality of sets of structures, each structure relating to a single item of the said one or more items and containing information representing the type of relationship between the item and said single item and the identity of the said single item, each set comprising structures containing information representing a common type of relationship.

8. A method as claimed in claim 7 wherein the indirect information consists of a plurality of sets of structures, each structure containing information representing a type of relationship and the identity of an item, each set comprising structures containing information representing a common type of relationship.

9. A method as claimed in claim 8 wherein the step of combining the direct information and the indirect information includes one or more operations, the nature of the operations being dependent on the nature of the items comprising the direct and indirect information.

10. A method for determining contextual information of an item which has one or more relationships with other items, the relationships being of two or more different types, the method comprising the steps of:
specifying a correspondence between a first and second type of relationship of the one or more relationships;
identifying one or more types of relationships to determine indirect information of the item;
determining direct information of the item by
determining first information by identifying one or more of the other items with which the item has a direct relationship;
determining second information by identifying one or more of the other items which have a relationship of the second type with items which are related to the item by a relationship of the first type;
combining the first and second information;
determining the indirect information of the item by determining contextual information of said one or more items with which the item has a relationship of a type used to determine the indirect information of the item; and
combining the direct information and the indirect information to determine the contextual information.

11. A method as claimed in claim 10 wherein said direct relationship is selected from a set of potential relationships.

12. A method as claimed in claim 11 wherein the selection of a direct relationship includes the step of determining the contextual information of the relationships in the set of potential relationships.

13. A method as claimed in claim 10 wherein the step of identifying one or more types of relationships which may be used to determine the indirect information of the item includes the step of determining the contextual information of each type of relationship.

14. A method as claimed in claim 10 wherein the step of determining first information includes assembling a plurality of sets of structures, each structure relating to a single item of the said one or more items and containing information representing the type of relationship between the item and said single item and the identity of the said single item, each set comprising structures containing information representing a common type of relationship.

15. A method as claimed in claim 14 wherein the step of determining second information includes assembling a plurality of sets of structures, each structure relating to a single item of the said one or more other items and containing information representing the type of relationship between the item and the item with which it has a relationship of the second type, and the identity of the said single item, each set comprising structures containing information representing a common type of relationship.

16. A method as claimed in claim 15 wherein the step of combining the first and second information includes one or more operations, the nature of the operations being dependent on the nature of the items comprising the direct and indirect information.

17. A method as claimed in claim 10 wherein the indirect information consists of a plurality of sets of structures, each structure containing information representing a type of relationship and the identity of an item, each set comprising structures containing information representing a common type of relationship.

18. A method as claimed in claim 17 wherein the step of combining the direct information and the indirect information includes one or more operations, the nature of the operations being dependent on the nature of the items comprising the direct and indirect information.
